(19) United States
(12) Patent Application Publication
(10) Pub. No.: US 2026/0154306 A1
(43) Pub. Date: Jun. 4, 2026

(54) USER PREFERENCE OPTIMIZED BASIC INPUT/OUTPUT SYSTEM CONFIGURATION VIA A RETRIEVAL-AUGMENTED GENERATION BASED SERVICE OR APPLICATION

(71) Applicant: DELL PRODUCTS L.P., Round Rock, TX (US)

(72) Inventors: Yung-Sheng Lin, Bade District (TW); Shun-Tang Hsu, Taipei (TW); Daniel Hamlin, Round Rock, TX (US)

(21) Appl. No.: 18/964,960

(22) Filed: Dec. 2, 2024

(51) Int. Cl. G06F 16/334; G06F 9/38

(52) U.S. Cl. CPC G06F 16/3344; G06F 9/3879

(57) ABSTRACT

An information handling system includes a processor and a memory coupled to the processor. In response to receipt of a query, the information handling system retrieves data from a retrieval-augmented generation (RAG) data store associated with the query. The information handling system transmits the query and the data from the RAG data store to an artificial intelligence model. In addition, the information handling system processes the query with the data using the artificial intelligence model to generate a response to the query. Further, in response to determining that the query includes a request to perform an action, the information handling system generates a command based on the request to perform the action and executes the command and provide the response that includes a status from the execution of the command.

### FIELD OF THE DISCLOSURE

The present disclosure generally relates to information handling systems, and more particularly relates to user preference optimized basic input/output system configuration via a retrieval-augmented generation based service or application.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communication among information handling systems may be via networks that are wired, wireless, or some combination.

### SUMMARY

An information handling system includes a processor and a memory coupled to the processor. In response to receipt of a query, the information handling system may retrieve data from a retrieval-augmented generation (RAG) data store associated with the query. The information handling system may transmit the query and the data from the RAG data store to an artificial intelligence model. In addition, the information handling system may process the query with the data using the artificial intelligence model to generate a response to the query. Further, in response to determining that the query includes a request to perform an action, the information handling system may generate a command based on the request to perform the action and execute the command and provide the response that includes a status from the execution of the command.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system for a user preference optimized basic input/output system (BIOS) configuration via a retrieval-augmented generation (RAG) based service or application, according to an embodiment of the present disclosure;

FIGS. 2-3 are flow diagrams of a method for a user preference optimized BIOS configuration via a RAG based service or application, according to an embodiment of the present disclosure;

FIG. 4 is a block diagram of a generalized information handling system, according to an embodiment of the present disclosure;

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

System information and basic input/output system (BIOS) configuration is typically a black box for end users. As such, the end users generally spend more time dealing with solving computer issues than they like, wherein solving the computer issues may include updating a system configuration or BIOS setting. This is generally something that a typical user wants to handle. On the other hand, computer manufacturers typically want their customers to have a favorable experience but generally need more feedback or information from their customers to assist their customers. Generally, the feedback and information received by the computer manufacturers from their customers are not received in real time. In addition, to get feedback and information, the manufacturer generally relies on the customers to fill out forms with system information that the customers may have difficulty identifying. Further, while assisting the customer, a service representative of the manufacturer may have to ask the customer to update a system configuration or BIOS setting. To address these and other concerns, the present disclosure provides a system and method for user preference optimized BIOS configuration via a retrieval-augmented generation (RAG) based service or application in addition to automatically logging user queries and feedback.

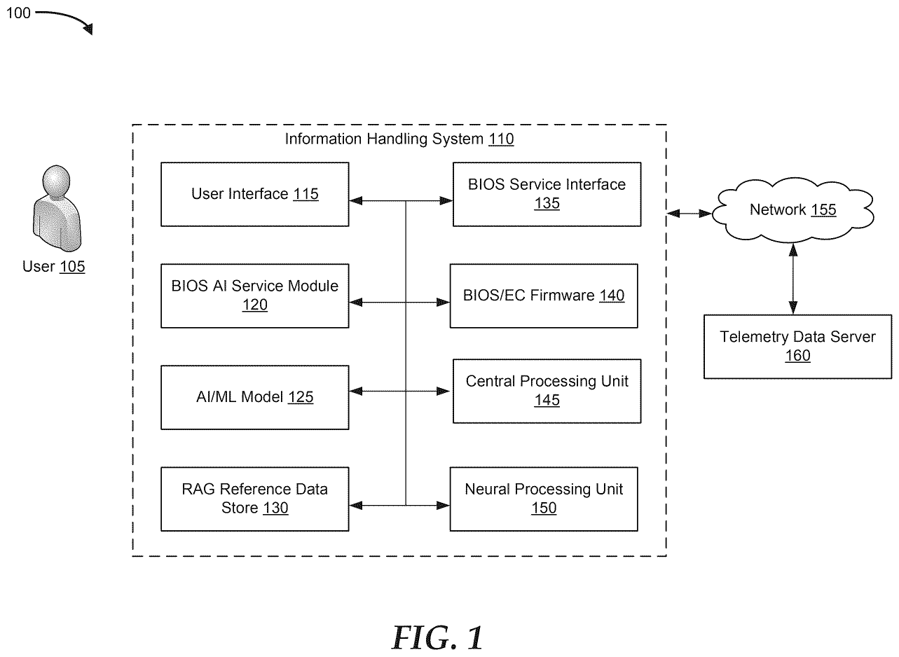

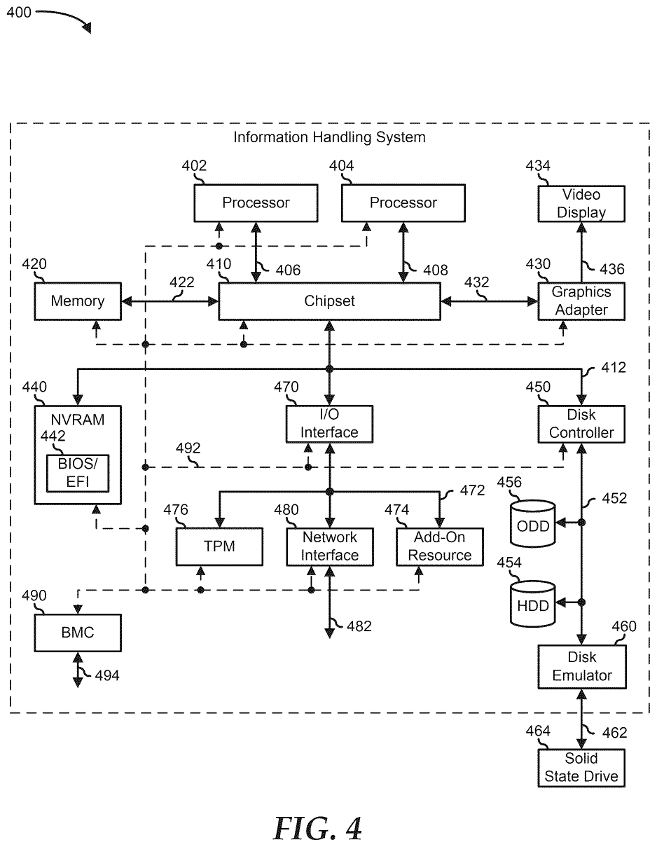

FIG. 1 illustrates a portion of a system 100 for user preference optimized BIOS configuration via RAG and/or artificial intelligence (AI) or machine learning (ML) model, according to an embodiment of the present disclosure. System 100 includes an information handling system 110, a network 155, and a telemetry data server 160. Information handling system 110, which is similar to an information handling system 400 of FIG. 4, includes a user interface 115, a BIOS AI service module 120, an AI/ML model 125, a RAG reference data store 130, a BIOS service interface 135, a BIOS/embedded controller (EC) firmware 140, a central processing unit (CPU) 145, and a neural processing unit (NPU) 150. As depicted, the aforementioned components may be interconnected. However, any variety of connections between these components is envisioned as falling within the scope of the present disclosure. In addition, connections between components may be omitted for descriptive clarity.

A user 105 may enter a query for BIOS AI service module 120 via user interface 115. The query may include a question in various formats, such as using the words “how” and “what.” The query may also include a request may ask BIOS AI service module 120 to “do something” or execute an action which typically involves a verb and/or an adverb. For example, user 105 may ask BIOS AI service module 120 via user interface 115 to update a BIOS setting. In another example, user 105 may be planning to purchase a computer game that has specific system requirements. User 105 may request BIOS AI service module 120 via user interface 115 to provide the system information of information handling system 110 to determine whether information handling system 110 supports the game.

In yet another example, user 105 may be a member of a service team of the manufacturer of information handling system 110. User 105 may use BIOS AI service module 120 via user interface 115 to inquire about current user trends and/or major system issues. In another example, user 105 encounters a system issue and would need to reinstall an operating system image. User 105 may use BIOS AI service module 120 via user interface 115 to enquire about how to reinstall the operating system. BIOS AI service module 120 via user interface 115 may provide guidance on the reinstallation and in addition may change the boot order to boot from a universal serial bus (USB) and enable USB-related boot settings for the next boot cycle. Accordingly, BIOS AI service module 120 may provide user 105 with a status of the changes, if any made via user interface 115.

User interface 115 may be a graphical user interface on a display associated with BIOS AI service module 120 that displays one or more windows with graphical controls, such as menus, text boxes, list boxes, action buttons, buttons, etc. User interface 115 may be used to assist user 105 with informational search tasks and/or transactional tasks. For example, user interface 115 may be used by user 105 to enter a query, which can include question, request, and/or feedback among others, wherein the query may be related to BIOS and/or system configuration of information handling system 110. User interface 115 may receive an image, video, string of text, or something similar on the display as a response to the query. The text of the output may also be parsed prior to display. User interface 115 may also be a command line interface, wherein user 105 may enter the query and receive the response.

BIOS AI service module 120 may comprise any system, device, or apparatus configured to receive a query which can be an informational search task and/or an actionable request from user 105 via a user interface 115. The informational search task is a query wherein the goal of the user is to answer a question. The actionable request is a query wherein the goal of the user is to perform a task or request. BIOS AI service module 120 may determine the intention of user 105, such as whether the query is an informational search task and/or transactional task. In particular, BIOS AI service module 120 may determine whether the query is a question or a request for an action. If the query is a request, then BIOS AI service module 120 may prompt AI/ML module 125 to generate a command based on the request.

In addition, BIOS AI service module 120 may determine whether the query it received is related to the BIOS or system configuration of information handling system 110. BIOS AI service module 120 may also transmit the query to AI/ML model 125 for processing, subsequent to pre-processing, if any. In this example, AI/ML model 125 is part of a framework utilizing RAG, wherein the RAG may be utilized to improve the quality of output of an AI/ML model by allowing the AI/ML model to access additional relevant data. Accordingly, BIOS AI service module 120 may also transmit the query to RAG reference data store 130 and AI/ML model 125 as an input, subsequent to pre-processing if any. During the pre-processing BIOS AI service module 120 may parse the query to determine information as above. Although BIOS AI service module 120 is shown implemented as a service, one of ordinary skill in the art will appreciate that the BIOS AI service module may be implemented as an application. Further, while BIOS AI service module 120 is shown as installed locally, one of ordinary skill in the art will appreciate that the BIOS AI service module may be installed remotely and accessible via network 155, for example.

AI/ML model 125 may implement a neural network, fuzzy logic, deep learning, deep structured learning hierarchical learning, support vector machine (SVM), decision tree learning, dimensionality reduction, or the like. The neural network may include an artificial neural network, deep neural network, convolutional neural network, recurrent neural network, transformers, auto encoders, reinforcement learning, etc. The SVM may include linear SVM, nonlinear SVM, SVM regression, etc. The decision tree learning may include classification and regression tree or “CART,” etc. AI/ML model 125 may be a small language model (SLM) or a large language model (LLM).

AI/ML model 125 may be configured to produce an output in response to the user's query. AI/ML model 125 may be trained on large datasets to provide an output for queries that are relevant to system configuration and/or BIOS settings. For example, AI/ML model 125 may be trained on data sets stored in telemetry data server 160. In addition, AI/ML model 125 may also be trained on data sets stored on RAG reference data store 130 which includes system configuration and BIOS-related data sets that are particular to the manufacturer of information handling system 110 and similar computing devices. In addition, RAG reference data store 130 may include data sets associated with a developer and/or provider of software and firmware installed within or similar. Accordingly, AI/ML model 125 may at least be partially trained on system information and BIOS configuration of various information handling system models. The output provided by AI/ML model 125 may include an answer to a question or the status of an action performed. AI/ML model 125 may also be configured to generate a command that can be executed via BIOS service interface 135 to process a request. As such, the output may also include information associated with the results of executing the generated command.

Although AI/ML model 125 is shown hosted locally by information handling system 110, one of ordinary skill in the art may appreciate that AI/ML model 125 may be hosted by a manufacturer or a third party at a cloud resource and accessible via an application programming interface (API). Alternatively, an on-premises server that is communicatively coupled to information handling system 110 may be used to host AI/ML model 125. In addition, although information handling system 110 is shown to include one AI/ML model, one of ordinary skill in the art will appreciate that information handling system 110 may include more than one AI/ML model.

RAG reference data store 130 may comprise any system, device, or apparatus that may include one or more data sets associated with BIOS and/or system configuration of one or more information handling systems. For example, RAG reference data store 130 may include a database with manufacturer-specific documents associated with information handling system 110 and/or BIOS/EC firmware 140. For example, RAG reference data store 130 may include system configuration, BIOS, and/or EC documents. In particular, RAG reference data store 130 may store specifications of the BIOS and/or the EC, common questions asked using the manufacturer's support website, and/or service requests, among others. RAG reference data store 130 may be located in a hidden drive partition, such as a hidden solid-state drive (SSD) partition. In one embodiment, the data stored in RAG reference data store 130 may be used as a training dataset for AI/ML model 125.

In addition, BIOS AI service module 120 may query RAG reference data store 130 to obtain relevant information associated with the query of user 105. The relevant information may be transmitted to AI/ML model 125. RAG reference data store 130 may be based on one or more data platforms such as relational databases, HADOOP™, etc. RAG reference data store 130 may include data sets that can be stored in various formats such as text files, extensible markup language (XML) files, comma-separated values (CSV) files, etc. RAG reference data store 130 may be located in a persistent storage device such as a solid-state disk, hard disk drive, magnetic tape library, optical disk drive, magneto-optical disk drive, compact disk drive, compact disk array, disk array controller, non-volatile random-access memory (NVRAM), and/or any computer-readable medium operable to store data.

A portion of data stored in RAG reference data store 130 may be used to train AI/ML model 125, while another portion of the data may be used to fine-tune the trained AI/ML model 125. Because the data stored in RAG reference data store 130 may be from the manufacturer of information handling system 110 and/or developer of BIOS/EC firmware 140, output, also referred to as a response provided by AI/ML model 125 may be tailored specifically and with reasonable accuracy to the system configuration, BIOS, functionality, and/or features of information handling system 110 and BIOS/EC firmware 140 among others. In addition, a portion of data stored in RAG reference data store 130 may be used to re-train a re-created version of AI/ML model 125, if any.

BIOS service interface 135 may comprise any system, device, or apparatus configured to provide an interface between BIOS/EC firmware 140 and BIOS AI service module 120. As such, BIOS service interface 135 may be configured to access BIOS/EC firmware 140 to manage, retrieve, provide access to, allow alteration, or update BIOS attributes and/or settings. BIOS service interface 135 performs other functions or operations as allowed. For example, user 105 may utilize user interface 115 to perform a request via BIOS AI service module 120, which may communicate the request to BIOS service interface 135. BIOS service interface 135 may then perform the request associated with BIOS/EC firmware 140. In one embodiment, BIOS service interface 135 may be coupled to BIOS/EC firmware 140 via a remote access controller administrator (RACADM), web services management (WSMAN), or similar. BIOS service interface 135 may be located in an NVRAM or similar memory with BIOS/EC firmware 140. In another embodiment, BIOS service interface 135 may be located externally to or remote from BIOS EC firmware and/or information handling system 110.

BIOS/EC firmware 140, may include a firmware that is similar to a BIOS/extensible firmware interface (EFI) 442 of FIG. 4, which may refer to the pre-boot firmware that the main processor executes at the beginning of every boot and any code that remains resident at runtime that was deployed by the pre-boot firmware. The role of this pre-boot firmware is to initialize memory, configure chipset and discrete devices on the motherboard, provide original equipment manufacturer (OEM) unique features, and enforce any customer-specific configuration settings managed by BIOS setup. Additionally, more recently the term unified extensible firmware interface (UEFI) has become much more prominent when discussing pre-boot firmware on information handling systems. The UEFI defines the various optional interfaces and protocols used by pre-boot firmware to configure an information handling system. However, the term “BIOS” is generally used to refer to any pre-boot firmware designed to bootstrap a modern PC, regardless of whether it is UEFI-based, Linux-based, or completely custom. For purposes of this disclosure, EFI and UEFI are used interchangeably and called UEFI for simplicity. Also, as used herein, legacy BIOS, as well as UEFI BIOS, are referred to as BIOS for simplicity.

BIOS/EC firmware 140 may also include a firmware that is similar to firmware associated with a baseboard management controller (BMC) 490 of FIG. 4. The EC firmware may be installed in a flash memory, wherein the EC comprises a Read-Only Memory (ROM) and a Random-Access Memory (RAM), and wherein the EC is configured to: read EC firmware from the flash memory to the RAM based on instructions encoded in the ROM; authenticate the EC firmware based on instructions encoded in the ROM; read the BIOS instructions from the flash memory to the RAM based on instructions included in the authenticated embedded controller firmware; authenticate the BIOS instructions based on instructions included in the authenticated EC firmware; and authorize booting of the information handling system from the authenticated BIOS instructions. In one embodiment, the EC firmware is responsible for low-level hardware interface functions such as power and reset management.

CPU 145, which is similar to processors 402 and 404 of FIG. 4, may comprise any system, device, or apparatus configured to perform or process various applications, firmware, and/or software of information handling system 110. For example, CPU 145 may perform any suitable operations to execute BIOS AI service module 120, AI/ML model 125, BIOS service interface 135, and BIOS/EC firmware 140.

NPU 150 may comprise any system, device, or apparatus configured and optimized to handle the complex computations required by AI, ML, and/or deep learning algorithms. This optimization makes an NPU efficient at processing AI, ML, and/or deep learning tasks, such as natural language processing, image analysis, and more. The NPU utilized by information handling system 110 may be of various types including a discrete NPU and an integrated NPU. Accordingly, NPU 150 may be configured to execute a workload associated with AI/ML model 125.

Network 155 may be implemented as or maybe a part of, a personal area network (PAN), a local area network (LAN), a metropolitan area network (MAN), a wide area network (WAN), a wireless local area network (WLAN), a virtual private network (VPN), an intranet, the Internet, or any other appropriate architecture or system that facilitates the communication of signals, data and/or messages. Network 155 may transmit data using any communication protocol, including without limitation, Fibre Channel, Frame Relay, Asynchronous Transfer Mode (ATM), Internet Protocol (IP), or other packet-based protocol. Network 155 and its various components may be implemented using hardware, software, or any combination thereof. These components may be configured to facilitate communication between information handling system 110 and telemetry data server 160. One of ordinary skill in the art will appreciate that system 100 may include more than one information handling system and telemetry data server. Accordingly, network 155 may be configured to facilitate communication between several information handling systems and telemetry data servers.

Telemetry data server 160 may comprise any system, device, or apparatus configured to receive telemetry data from an information handling system, wherein the telemetry data is associated with the system and BIOS configuration of one or more information handling systems, among others. For example, logs for each phase of the boot process may be stored in telemetry data server 160. The telemetry data may also be associated with issues detected during a boot process of an information handling system. In this example, during a system failure, failure logs may also be sent to telemetry data server 160. In addition, data from the manufacturer support site may also be stored in telemetry data server 160. Further, telemetry data server 160 may be configured to store queries, responses, and/or feedback from one or more users, among other data. As such, an application may be configured to aggregate and analyze the telemetry data. Although telemetry data server 160 is shown to be located remotely, wherein the telemetry data may be received from one or more sources, one of ordinary skill in the art will appreciate that information handling system may include a local telemetry data store.

Those of ordinary skill in the art will appreciate that the configuration, hardware, and/or software components of system 100 may vary. For example, AI/ML model 125, BIOS AI service module 120, and RAG reference data store 130 are shown as part of information handling system 110, but these components may be on distinct devices, in whole or in part. For example, RAG reference data store 130 may be stored on a remote server similar to or included as part of telemetry data server 160. In addition, the illustrative components within system 100 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

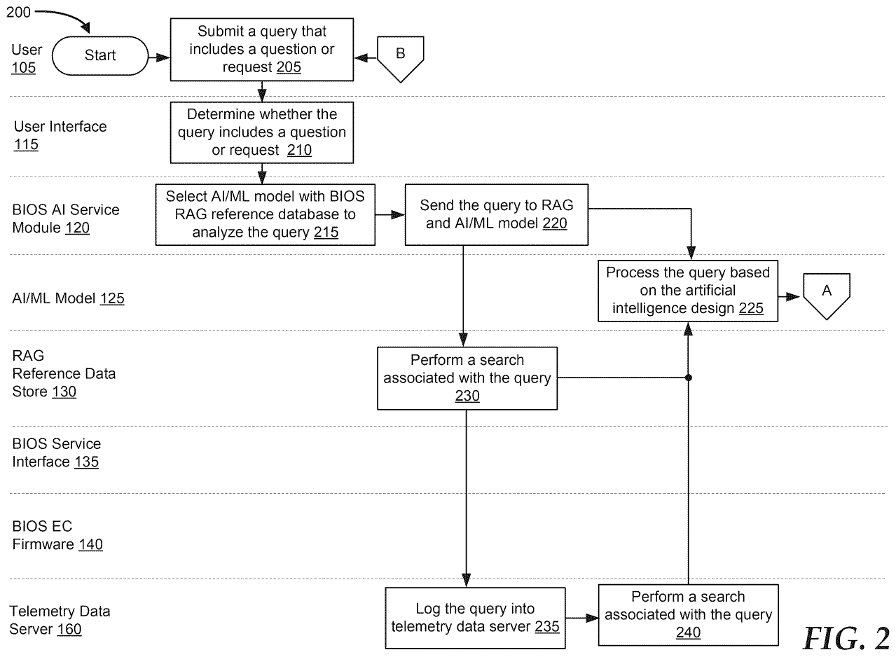

FIG. 2 illustrates a flow diagram of a method 200 for user preference optimized basic input/output system configuration via a retrieval-augmented generation based service or application, according to an embodiment of the present disclosure. Method 200 may be performed by any suitable component of system 100 including, but not limited to, user interface 115, BIOS AI service module 120, RAG reference data store 130, BIOS service interface 135, BIOS/EC firmware 140, CPU 145, NPU 150, and telemetry data server 160 of FIG. 1. While embodiments of the present disclosure are described in terms of the components of system 100 of FIG. 1, it should be recognized that other components may be utilized to perform the described method. One of skill in the art will appreciate that this flow diagram explains a typical example, which can be extended to applications or services in practice. It will be readily appreciated that not every block set forth in this flow diagram is always necessary and that certain blocks of the methods may be combined, performed simultaneously, in a different order, or perhaps omitted, without varying from the scope of the disclosure.

Method 200 may be configured to improve a user's experience by providing a response to a user's query and/or performing a user's request via AI techniques. Method 200 typically starts at block 205 where user 105 may submit a query via user interface 115. User 105 may ask a question or provide a request specific to a system configuration or BIOS of an information handling system. After receiving the query, the method may proceed to block 210.

At block 210, user interface 115 may be used to identify whether the query includes a question or request related to BIOS/system configuration. In one embodiment, current system information along with other BIOS-related data, such as BIOS options list, BIOS specification, etc. may be stored in RAG reference data store 130. AI/ML model 125 or an AI/ML classification algorithm may be used to determine whether the query includes a system configuration or BIOS-related question, or request based on the documents stored in RAG reference data store 130. In another embodiment, the method may also use one or more rule-based classification algorithms based also in part on the documents stored in RAG reference data store 130 to classify the query and produce an output, wherein the output may indicate a probability whether the query includes a question or request. The method may proceed to block 215.

At block 215, a BIOS AI service module 120 may select an AI/ML model with a RAG data store, such as AI/ML model 125 with RAG reference data store 130 to analyze the query of user 105. In one example, when a user of a Dell® laptop queries about how to update a BIOS setting, that user may care about how to update a BIOS setting specific to the BIOS version specific to his or her laptop. Accordingly, the user may not care about how to update a BIOS setting or EC setting of a laptop of another manufacturer, such as Lenovo® for example. Because RAG reference database 130 includes system specific and BIOS-related information, this information may be used to increase the precision of AI/ML 125's response to the user's query. The method may proceed to block 220 where BIOS AI service module 120 may send the query to RAG reference data store 130 and AI/ML model 125. The method may proceed to blocks 225 and 230.

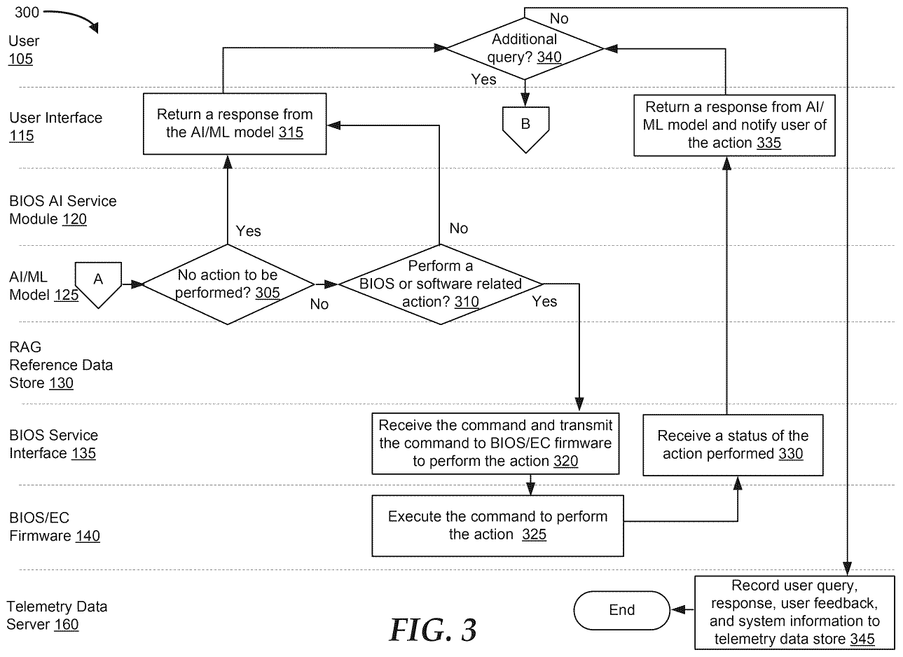

At block 225, the AI/ML model 125 may process the query and generate a response, also referred to as feedback, to the query according to the AI framework design of the system. For example, processing the query may include data from RAG reference data store 130 and telemetry data server 160. This design may allow AI/ML model 125 to have access to updated data stored in RAG reference data store 130 and/or telemetry data server without having to retrain AI/ML model 125. In addition, this design may allow AI/ML model 125 to have access to data that AI/ML 125 has not been previously trained on. The response to the query may include an answer to a question or a status of an action based on a request. The method may proceed to decision block 305 of FIG. 3.

At block 230, the BIOS AI service module 120 may perform a search associated with the query at RAG reference data store 130. BIOS AI service module 120 may search RAG reference data store 130 for additional and/or updated data that relates to a current system configuration and/or BIOS settings based on the query. For example, while AI/ML model 125 can produce a response to the query that may seem relevant, AI/ML model 125 may not have a mechanism to decipher between a response relevant to the current system configuration and/or BIOS settings associated with a particular manufacturer. By utilizing the data from RAG reference data store 130, AI/ML model 125 may be able to filter out non-relevant information, such as information from other manufacturers, and provide a more accurate response. The method may proceed to blocks 225 and 235.

At block 235, BIOS AI service module 120 may log the query at telemetry data server 160. The method may proceed to block 240 where BIOS AI service module 120 may search telemetry data server 160 for data related to the current processing task of AI/ML model 125. The related data may be transmitted to block 225, wherein the related data along with the data from RAG reference data store 130 may be included in the processing of the query by AI/ML model 125.

FIG. 3 illustrates a flow diagram of method 300 which is a continuation of method 200 of FIG. 2. Method 300 typically starts at decision block 305 where AI/ML model 125 may determine whether the query does not require or needs an intervention or action to be performed based on the request included in the query. An action may include adding, editing, updating, or removing a firmware/software setting, system configuration setting, and/or BIOS setting. The action may also refer to applying a software or firmware update, such as performing a BIOS or EC firmware update, wherein the software or firmware update may be to upgrade or downgrade the software or firmware version. In addition, the action may include adding, editing, updating, or removing a setting of an embedded controller, BMC, or similar. If the query does not require an action, then the “YES” branch is taken, and the method proceeds to block 315. If the query may require an action, then the “NO” branch is taken, and the method proceeds to decision block 310.

At decision block 310, AI/ML model 125 may determine whether there may be a need to perform a system configuration, BIOS, software, or firmware-related action. There may be an action to be performed if the query includes a request. AI/ML model 125 may provide information associated with the state of the information handling system that may require user intervention or action. For example, the information may provide the current state of the information handling system, such as its performance, battery life, system fan, etc. below a certain threshold. As such, the information may provide data on how the user can intervene or perform an action to remediate or mitigate an issue associated with the current state of the information handling system. For example, the information may include one or more options to adjust a system configuration or BIOS update. In a particular example, the information may include two options, wherein the first option may be to adjust a battery or performance setting in an operating system setting. The second option may be to enable overclocking via a BIOS interface.

If the query does not include a request, such as the query only includes a question, then there may not be an action to be performed. In addition, AI/ML model 125 may determine whether to perform the action automatically or manually by the user. For example, AI/ML model 125 may provide a dialog that asks user 105 whether the user prefers that the action be performed automatically or manually. If user 105 elected for the action to be performed automatically, then the method may proceed with performing one or more of the actions based on the user feedback. If user 105 elected to manually perform the action, then the method may provide one or more options and allow user 105 to choose among the options. If there is an action to be performed, then the “YES” branch is taken, and the method proceeds to block 320. If there is no action to be performed, then the “NO” branch is taken, and the method proceeds to block 315.

At block 315, user interface 115 may return a response from AI/ML model 125, wherein the response can also be based on the information stored in RAG reference data store 130 and/or telemetry data server 160. The response may include an answer to the question included in the query of user 105. The method may proceed to decision block 340. At block 320, BIOS service interface 135 may receive a command from AI/ML model 125, wherein the command is based on the action. In one example, the command may be generated by AI/ML model 125. BIOS service interface 135 may send the command to BIOS/EC firmware 140 automatically or subsequent to the selection of an option by user 105. The command may used to perform one of the enumerated actions above, such as to update a system configuration or BIOS setting. The method may proceed to block 325.

At block 325, BIOS/EC firmware 140 may execute the command to perform the action. After executing the command, the method may proceed to block 330 where BIOS service interface 135 may receive the status associated with the action performed. For example, the status may be a notification that the action was a success or a failure. The status may also include other information associated with the result of the action. For example, the status may include a value of an updated system configuration or BIOS setting. The method may proceed with block 335.

At block 335, user interface 115 may provide a response generated by AI/ML model 125 when it processed the query, such as at block 225. The response may also include the status and/or other information based on the action performed at block 325. For example, the response may notify user 105 which system configuration or BIOS setting was updated and whether the update was successful or not. The response may also include the value of the updated system configuration or BIOS setting. The method may proceed to decision block 340.

At decision block 340, BIOS AI service module 120 may determine whether there is an additional query from user 105. For example, BIOS AI service module 120 may provide a dialog to determine whether user 105 has an additional query. If user 105 has an additional query, then the “YES” branch is taken, and the method proceeds to block 205 of FIG. 2. BIOS AI service module 120 may flag this information as user feedback that user 105 may not have been satisfied with the response received from AI/ML model 125. BIOS AI service module 120 may align this flag with additional user feedback if any. For example, if user 105 noted that he or she was satisfied with the response from AI/ML model 125, then the flag may be rendered irrelevant information and deleted. If user 105 has no more query, then the “NO” branch is taken, and the method proceeds to block 345. BIOS AI service module 120 may flag this information as user feedback that user 105 may have been satisfied with the response received from AI/ML model 125.

At block 345, BIOS AI service module 120 may store or record user query, feedback, system information, or any related information to the query, such as the status of the action performed if any, in telemetry data server 160. In addition, user feedback that indicates whether the response is relevant/accurate or not may also be recorded or stored. The recorded or stored information may be used to further train and fine-tune AI/ML model 125, which can improve the accuracy and/or relevance of the response provided by AI/ML model 125.

FIG. 4 illustrates an embodiment of an information handling system 400 including processors 402 and 404, a chipset 410, a memory 420, a graphics adapter 430 connected to a video display 434, a non-volatile RAM (NVRAM) 440 that includes a basic input and output system/extensible firmware interface (BIOS/EFI) module 442, a disk controller 450, a hard disk drive (HDD) 454, an optical disk drive 456, a disk emulator 460 connected to a solid-state drive (SSD) 464, an input/output (I/O) interface 470 connected to an add-on resource 474 and a trusted platform module (TPM) 476, a network interface 480, and BMC 490. Processor 402 is connected to chipset 410 via processor interface 406, and processor 404 is connected to the chipset via processor interface 408. In a particular embodiment, processors 402 and 404 are connected together via a high-capacity coherent fabric, such as a HyperTransport link, a QuickPath Interconnect, or the like. Chipset 410 represents an integrated circuit or group of integrated circuits that manage the data flow between processors 402 and 404 and the other elements of information handling system 400. In a particular embodiment, chipset 410 represents a pair of integrated circuits, such as a northbridge component and a southbridge component. In another embodiment, some or all of the functions and features of chipset 410 are integrated with one or more of processors 402 and 404.

Memory 420 is connected to chipset 410 via a memory interface 422. An example of memory interface 422 includes a Double Data Rate (DDR) memory channel and memory 420 represents one or more DDR Dual In-Line Memory Modules (DIMMs). In a particular embodiment, memory interface 422 represents two or more DDR channels. In another embodiment, one or more of processors 402 and 404 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 420 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 430 is connected to chipset 410 via a graphics interface 432 and provides a video display output 436 to a video display 434. An example of a graphics interface 432 includes a Peripheral Component Interconnect-Express (PCIe) interface and graphics adapter 430 can include a four-lane (×4) PCIe adapter, an eight-lane (×8) PCIe adapter, a 16-lane (×16) PCIe adapter, or another configuration, as needed or desired. In a particular embodiment, graphics adapter 430 is provided down on a system printed circuit board (PCB). Video display output 436 can include a DVI, an HDMI, a DisplayPort interface, or the like, and video display 434 can include a monitor, a smart television, an embedded display such as a laptop computer display, or the like.

NVRAM 440, disk controller 450, and I/O interface 470 are connected to chipset 410 via an I/O channel 412. An example of I/O channel 412 includes one or more point-to-point PCIe links between chipset 410 and each of NVRAM 440, disk controller 450, and I/O interface 470. Chipset 410 can also include one or more other I/O interfaces, including a PCIe interface, an Industry Standard Architecture (ISA) interface, a Small Computer Serial Interface (SCSI) interface, an I²C interface, a System Packet Interface, a Universal Serial Bus (USB), another interface, or a combination thereof. NVRAM 440 includes BIOS/EFI module 442 that stores machine-executable code (BIOS/EFI code) that operates to detect the resources of information handling system 400, to provide drivers for the resources, to initialize the resources, and to provide common access mechanisms for the resources. The functions and features of BIOS/EFI module 442 will be further described below.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an institute of electrical and electronics engineers (IEEE) 1394 (Firewire) interface, a proprietary interface, or a combination thereof. Alternatively, SSD 464 can be disposed within information handling system 400.

I/O interface 470 includes a peripheral interface 472 that connects the I/O interface to add-on resource 474, to TPM 476, and to network interface 480. Peripheral interface 472 can be the same type of interface as I/O channel 412 or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral interface 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on a separate circuit board, or add-in card disposed within information handling system 400, a device that is external to the information handling system, or a combination thereof.

Network interface 480 represents a network communication device disposed within information handling system 400, on a main circuit board of the information handling system, integrated onto another component such as chipset 410, in another suitable location, or a combination thereof. Network interface 480 includes a network channel 482 that provides an interface to devices that are external to information handling system 400. In a particular embodiment, network channel 482 is of a different type than peripheral interface 472 and network interface 480 translates information from a format suitable to the peripheral channel to a format suitable to external devices.

In a particular embodiment, network interface 480 includes a NIC or host bus adapter (HBA), and an example of network channel 482 includes an InfiniBand channel, a Fibre Channel, a Gigabit Ethernet channel, a proprietary channel architecture, or a combination thereof. In another embodiment, network interface 480 includes a wireless communication interface, and network channel 482 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 482 can be connected to an external network resource (not illustrated). The network resource can include another information handling system, a data storage system, another network, a grid management system, another suitable resource, or a combination thereof.

BMC 490 is connected to multiple elements of information handling system 400 via one or more management interface 492 to provide out of band monitoring, maintenance, and control of the elements of the information handling system. As such, BMC 490 represents a processing device different from processor 402 and processor 404, which provides various management functions for information handling system 400. For example, BMC 490 may be responsible for power management, cooling management, and the like. The term BMC is often used in the context of server systems, while in a consumer-level device, a BMC may be referred to as an EC. A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 490 can vary considerably based on the type of information handling system. BMC 490 can operate in accordance with an Intelligent Platform Management Interface (IPMI). Examples of BMC 490 include an Integrated Dell® Remote Access Controller (iDRAC).

Management interface 492 represents one or more out-of-band communication interfaces between BMC 490 and the elements of information handling system 400, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 400, that is apart from the execution of code by processors 402 and 404 and procedures that are implemented on the information handling system in response to the executed code.

BMC 490 operates to monitor and maintain system firmware, such as code stored in BIOS/EFI module 442, option ROMs for graphics adapter 430, disk controller 450, add-on resource 474, network interface 480, or other elements of information handling system 400, as needed or desired. In particular, BMC 490 includes a network interface 494 that can be connected to a remote management system to receive firmware updates, as needed or desired. Here, BMC 490 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 490 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 490, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 490 is included on a main circuit board (such as a baseboard, a motherboard, or any combination thereof) of information handling system 400 or is integrated onto another element of the information handling system such as chipset 410, or another suitable element, as needed or desired. As such, BMC 490 can be part of an integrated circuit or a chipset within information handling system 400. An example of BMC 490 includes an iDRAC, or the like. BMC 490 may operate on a separate power plane from other resources in information handling system 400. Thus BMC 190 can communicate with the management system via network interface 494 while the resources of information handling system 400 are powered off. Here, information can be sent from the management system to BMC 190 and the information can be stored in a RAM or NVRAM associated with the BMC. Information stored in the RAM may be lost after power-down of the power plane for BMC 490, while information stored in the NVRAM may be saved through a power-down/power-up cycle of the power plane for the BMC.

Information handling system 400 can include additional components and additional buses, not shown for clarity. For example, information handling system 110 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 400 can include multiple central processing units (CPUs) and redundant bus controllers. One or more components can be integrated together. Information handling system 400 can include additional buses and bus protocols, for example, I²C and the like. Additional components of information handling system 110 can include one or more storage devices that can store machine-executable code, one or more communications ports for communicating with external devices, and various input and output (I/O) devices, such as a keyboard, a mouse, and a video display.

For purposes of this disclosure information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 400 can include processing resources for executing machine-executable code, such as processor 402, a programmable logic array (PLA), an embedded device such as a System-on-a-Chip (SoC), or other control logic hardware. Information handling system 400 can also include one or more computer-readable media for storing machine-executable code, such as software or data.

Although FIG. 2 and FIG. 3 show example blocks of method 200 and method 300 in some implementations, method 200 and method 300 may include additional blocks, fewer blocks, different blocks, or differently arranged blocks than those depicted in FIG. 2 and FIG. 3. Those skilled in the art will understand that the principles presented herein may be implemented in any suitably arranged processing system. Additionally, or alternatively, two or more of the blocks of method 200 and method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
in response to receiving a query, retrieving, by a processor, data from a retrieval-augmented generation (RAG) data store associated with the query;
transmitting the query and the data to an artificial intelligence model;
processing the query with the data using the artificial intelligence model to generate a response to the query;
in response to determining that the query includes a request to perform an action, generating a command based on the request to perform the action; and
executing the command and providing the response to the query that includes a status from the executing of the command.

2. The method of claim 1, wherein the query is related to a system configuration of an information handling system.

3. The method of claim 1, wherein the query is related to a basic input/output system (BIOS) of an information handling system.

4. The method of claim 1, wherein the RAG data store includes system configuration related data.

5. The method of claim 1, wherein the processing of the query further includes processing data from a telemetry data store.

6. The method of claim 1, wherein artificial intelligence model is a large language model.

7. The method of claim 1, further comprising transmitting the status associated with the executing of the command to a user interface.

8. An information handling system, comprising:
a processor; and
a memory coupled to the processor, the memory having program instructions stored thereon that upon execution cause the processor to:
in response to receipt of a query, retrieve data from a retrieval-augmented generation (RAG) data store associated with the query;
transmit the query and the data from the RAG data store to an artificial intelligence model;
process the query with the data using the artificial intelligence model to generate a response to the query;
in response to determining that the query includes a request to perform an action, generate a command based on the request to perform the action; and
execute the command and provide the response that includes a status from the execution of the command.

9. The information handling system of claim 8, wherein the query is related to a system configuration of the information handling system.

10. The information handling system of claim 8, wherein the query is related to a basic input/output system (BIOS) of the information handling system.

11. The information handling system of claim 8, wherein the RAG data store includes system configuration related data.

12. The information handling system of claim 8, wherein to process the query further includes to process data from a telemetry data store.

13. The information handling system of claim 8, wherein the execution further causes the processor to transmit the status associated with the execution of the command to a user interface.

14. A non-transitory computer-readable medium to store instructions that are executable to perform operations comprising:
in response to receiving a query, retrieving, by a processor, data from a retrieval-augmented generation (RAG) data store associated with the query;
transmitting the query and the data to an artificial intelligence model;
processing the query with the data using the artificial intelligence model to generate a response to the query;
in response to determining that the query includes a request to perform an action, generating a command based on the request to perform the action; and
executing the command and providing the response to the query that includes a status from the executing of the command.

15. The non-transitory computer-readable medium of claim 14, wherein the query is related to a system configuration of an information handling system.

16. The non-transitory computer-readable medium of claim 14, wherein the query is related to a basic input/output system (BIOS) of an information handling system.

17. The non-transitory computer-readable medium of claim 14, wherein the RAG data store includes system configuration related data.

18. The non-transitory computer-readable medium of claim 14, wherein the processing of the query further includes data from a telemetry data store.

19. The non-transitory computer-readable medium of claim 14, wherein the artificial intelligence model is a small language model.

20. The non-transitory computer-readable medium of claim 14, wherein the operations further comprise transmitting the status associated with the executing of the command to a user interface.
